(19) United States
(12) Patent Application Publication
(10) Pub. No.: US 2014/0308424 A1
(43) Pub. Date: Oct. 16, 2014

(54) DRIED PULP PREPARATION FROM UNPROCESSED RAW MATERIALS

(71) Applicants: Hua Bai, Shanghai (CN); Yong-Cheng Liao, Beijing (CN); Zhong-wei Sun, Beijing (CN); Olivier Ballevre, Amiens (FR); Qingzhu Zhao, Beijing (CN)

(72) Inventors: Hua Bai, Shanghai (CN); Yong-Cheng Liao, Beijing (CN); Zhong-wei Sun, Beijing (CN); Olivier Ballevre, Amiens (FR); Qingzhu Zhao, Beijing (CN)

(73) Assignee: NESTEC S.A., Vevey (CH)

(21) Appl. No.: 14/234,316

(22) PCT Filed: Jul. 22, 2011
(86) PCT No.: PCT/CN2011/077501

§ 371 Date: Apr. 24, 2014

(51) Int. Cl. A23L 2/395

(52) U.S. Cl. CPC A23L 2/395
USPC 426/590; 426/640

(57) ABSTRACT

Disclosed is dried fruit or vegetable pulp preparation comprising dried fruit or vegetable pulp and at least one density modifying ingredient. The density modifying ingredient may be selected from the group consisting of complex carbohydrates or humectants.

The present invention relates generally to the field of food and beverages. In particular, the present invention relates to dried fruit and vegetable pulp and to products containing such pulp preparations. One embodiment relates to a dried fruit or vegetable pulp preparation comprising a density modifying ingredient.

Beverages on the basis of fruit juices or fruit flavours are generally well-liked by consumers and are perceived as refreshing, in particular during the warm season, while at the same time they generally are beneficial to the consumer's health.

Sometimes it is not possible or too expensive to produce such beverages directly from fresh fruits due to seasonal or regional limitation. In such cases, beverages on the basis of fruit juices or fruit flavours are produced from concentrate, e.g. from powdered beverages.

Most of the currently sold natural powered or solid beverage preparations contain fruit powder which fully dissolves after reconstitution in water. Such a fruit powder is often prepared by spray drying. The dissolution of the fruit powder in the beverage has however the consequence that consumers often do not perceive the presence of fruit.

To overcome this, pulp particles may be added to fruit juice preparations. The presence of pulp particles in beverages is considered as pleasant by the consumer as it more closely resembles the mouth feel of freshly squeezed fruit juices, for example. However, the application of dehydrated fruit pulp to powdered beverages to deliver a pulp mouthfeel after reconstitution is not a simple task to accomplish reasons, e.g., due to costs or technical limitations.

Some patent applications have been published in this respect.

For example, U.S. Pat. No. 4,233,334 discloses a dry powdered beverage mix adapted to be reconstituted in cold water. The powdered mix includes beaten cellulose pulp, which imparts an appearance and mouth-feel resembling freshly squeezed natural juice. When preparing the dry powdered beverage mix, the beaten pulp is mixed with sugar, and the pulp/sugar mixture is air dried to form a dry cake which is then crushed to a powder.

Pulp is in particularly perceived as pleasant, if it is visible in the beverage, well hydrated and maintains a floating status in the beverage.

EP0098120B1 addresses the problem that natural citrus pulp often is not easy to rehydrate after drying and hence often clumps and generates particles with a high density. It is suggested to adjust the pH of citrus pulp to at least 4.0 before freeze drying the pulp to a moisture content of less than 10 weight-% and grinding it. This way a dried citrus pulp with improved wetting and dispersion characteristics is obtained.

The presence of sugar particles and pulp particles, e.g. in a powdered beverage composition, has the consequence that the robust and sharp edged sugar particles grind the pulp particles and—consequently—destroy at least in part the pulp structure. Similar friction effects can also be observed in between the pulp particles. This happens in particular during production and transport, but also during storage times. Additionally, it is a technical challenge to mix relatively low density pulp with sugar particles to homogeneity during processing. Further segregation could be observed during transportation and storage.

The results are pulp particle segregation, impaired hydration properties, and an impaired mouthfeel of the final product after reconstitution with milk or water.

Consequently, it was the objective of the present invention to produce pulp, e.g., for powdered beverages, that is clearly visible after reconstitution in water, has good rehydration properties, has a pleasant chewy mouthfeel, and a density range that allows that the pulp maintains a floating status.

Ideally, such a pulp should be obtainable by a process with a high freeze drying efficiency for dried pulp resulting in pulp which is less cohesive and caking is avoided.

The present inventors have addressed these needs.

They were surprised to see that they could achieve this objective by the subject matter of the independent claims. The dependent claims further develop the idea of the present invention.

The inventors were surprised to see that the addition of a density modifying ingredient, e.g., complex carbohydrates or glycerol to the pulp preparation before the drying step overcomes the problems of the state of the art and achieves the object of the present invention.

For example, if the pulp preparations are dried in the presence of complex carbohydrates with a low water solubility, such as starch, the sticking of pulp particles is avoided.

If the pulp preparations are dried in the presence of a humectant, such as glycerol, rather soft pulp particles can be obtained. Such pulp particles were found to be more resistant towards mechanical stress. Consequently, unwanted particle breakage can be avoided.

Further, the rather soft particles avoid unnecessary friction between the pulp particles and the resulting segregation.

Further, the inventors found that the addition of complex carbohydrates allowed it to adjust the pulp density. This adjusted pulp density allows it to better meet varying requirements in the preparation of different products.

Without wishing to be bound by theory, the inventors believe that this effect is due to the fact that humectants can make pulp particles soft and reduce the friction between pulp particles. Complex carbohydrates are water insoluble and are believed to prevent unwanted sticking between pulp particles.

Consequently, one embodiment of the present invention is a dried fruit or vegetable pulp preparation comprising dried fruit or vegetable pulp and a density modifying ingredient.

A fruit or vegetable pulp preparation is considered dried if it has a water content of below 10 weight-%, below 5 weight-%, or for example below 3 weight-%.

Those skilled in the art will be able to identify density modifying ingredients. Dry density modifying ingredients may contain less than 10 weight-%, less than 3 weight %, less than weight-%, or no water. Density modifying ingredients also have a higher density that the dried pulp to be produced and can be rehydrated with water.

The density modifying ingredient may be selected from the group consisting of complex carbohydrates or humectants.

A suitable humectant may be glycerol, for example.

Ideally, the at least one complex carbohydrate should be not soluble in water.

For the purpose of the present invention a compound is considered to have a low solubility in water if 10 weight-% of the compound do not dissolve substantially completely in water at room temperature during 30 minutes.

The density modifying ingredients may be present in an amount corresponding to about at least 0.5 weight-%, at least 10 weight-% or at least 20 weight-% compared to the dry weight of the pulp.

The complex carbohydrate which has a low solubility in water may be starch, for example.

The density modifying ingredient may consist out of at least one complex carbohydrate.

It may also contain at least 1 weight %, at least 10 weight-%, at least 20 weight %, or at least 50 weight-% of a complex carbohydrate which has a low solubility in water; and in addition other carbohydrates.

These other carbohydrates may or may not be water soluble.

Water soluble sugars may be used.

Typical sugars may be maltodextrin, glucose, trehalose, sucrose, maltose, lactose or combinations thereof, for example.

Consequently, the fruit or vegetable pulp preparation may comprise a density modifying ingredient comprising a mixture of at least one sugar and/or at least one complex carbohydrate.

The density modifying ingredient may further contain a humectants, such as glycerol, for example.

Typically, the fruit or vegetable pulp preparation is obtainable—and may be obtained—by a process comprising the steps of separating the pulp from the fruits or vegetables, adding the density modifying ingredient to the pulp and drying the pulp.

Separating the pulp from the fruit allows removing all constituents of fruits or vegetables that would impart unwanted tastes or properties to the pulp preparation. Oftentimes, for example, the skin of fruits has a somewhat bitter taste.

For example, in case of oranges or pomelos, the outer skin, membranes and seeds are removed and only the pulp is used for further processing.

The density modifying ingredient is added to the pulp before the drying step. This allows homogeneous distribution and allows the density modifying ingredient to protect the pulp during the subsequent drying process and avoids unwanted cohesion.

Drying allows reducing the water activity and the water content of the pulp allowing easy storing and avoiding decay processes.

The fruit or vegetable pulp may be dried by any method that is known in the art.

For example, the pulp may be dried by, for example, by air drying (AD), freeze draying (FD), roller drying, spray drying, vacuum drying (VD), microwave drying, or combinations thereof.

The inventors have explored several drying techniques and were surprised to see that freeze drying had several advantages compared to other drying techniques.

Freeze dried pulp had excellent visual properties, also after reconstitution, significantly better compared to other drying techniques.

Freeze drying also allowed generating an improved floating status of the pulp after reconstitution in water.

Freeze drying further allowed delivering a pulp with a superior chewy perception after reconstitution.

Freeze dried pulp was also shown to have the best rehydration properties.

Freeze drying also allowed it to minimize pulp shrinkage during the drying procedure compared to other drying processes.

Fruit pulp is usually produced from waste products in the juice production, e.g. from citrus grain after juice extraction. Oftentimes the grains are dried before they are applied to pulp production.

Such pulp can very well be used in the context of the present invention and would allow valorisation of a product that would otherwise be thrown away.

However, the present inventors were able to demonstrate that dried fruit or vegetable pulp obtained from fresh fruits or vegetables has superior properties compared to pulp obtained from waste products of the juice production.

In addition, using fresh whole fruit or vegetables as pulp source is a commercially very interesting alternative as the costs contribution for the raw materials is reduced per kg pulp when fresh unprocessed fruits or vegetables are used.

The inventors have found that when waste products or by-products from juice production are used, more working steps are needed to produce pulp, resulting in higher labour cost. This has the consequence that using whole fruits or vegetables as starting material for pulp production may be more economic.

Remarkably, dried fruit or vegetable pulp obtained from unprocessed fresh fruit or vegetables as starting material provided a much better mouthfeel after reconstitution in water. A unique, very pleasant chewy texture was obtained, which could not be produced with pulp from waste material of juice production.

Fruits or vegetables are considered “unprocessed” if they are used as such as raw material to prepare pulp and were in particular not treated beforehand to remove the juice prior to pulp collection, for example by squeezing or beating the fruit or vegetable to extract the juice. Typically, the flesh of the fruits or vegetables is used to prepare the pulp. Peeled fruit or vegetables may be considered as unprocessed.

Without wishing to be bound by theory, the inventors believe that this difference is due to the fact that in pulps obtained from processed fruits or vegetables the texture and structure of the pulp is significantly damaged by the strong squeezing or beating operation.

If unprocessed fruits or vegetables are used for dried pulp production, the fruit or vegetable grain is protected and will not be damaged during pulp production.

Consequently, advantageously, the dried fruit or vegetable pulp preparation may be obtained from fresh, unprocessed fruits or vegetables.

Fruits or vegetables are considered “fresh” if they are used within normal consumption times after harvest. These time frames may vary depending on the fruit or vegetable. For example, a fresh fruit is not dried and has a water content corresponding to at least 50%, preferably at least 75% even more preferred at least 90% corresponding to the fruit or vegetable directly after harvest.

Remarkably, by using fresh unprocessed fruit or vegetables as starting material, a maximum of their nutrients can be retained and their naturality can be best preserved when drying.

Notably, the inventors also found that using fresh unprocessed fruit or vegetables as starting material rather than processed fruit pulp after squeezing out juice, allows increasing the freeze drying efficiency significantly so that far less cost spent on raw material is needed for obtaining a fixed amount of dried pulp.

For example, 10 kg squeezed orange pulp allowed to prepare 1 kg of dried orange pulp. If using fresh oranges as starting material, 17 kg fresh oranges were sufficient to prepare 1 kg dried orange pulp. The purchasing price for a kg of squeezed orange pulp is 3-4 times higher than the purchasing price for fresh oranges. Consequently, by using unprocessed fruit as starting material the costs per kg of dried pulp can be reduced significantly.

The fruit or vegetable pulp may be cut before drying, e.g., in particular before freeze drying. Cutting the pulp, e.g., into cubes or other shapes allows improving the rehydration properties of the resulting pulp preparation.

The pulp may be cut into pieces with an edge length in the range of about 0.5-30 mm. For example, the pulp may be cut into cubes with an edge length in the range of 0.5-30 mm, for example 3-6 mm.

The inventors have found particular good properties for cubes with an edge length of about 3 or about 6 mm. The dicing size has an effect on pulp size and visual properties. Cubes with a longer edge length produce bigger pulp segments after reconstitution and the risk to produce unwanted very fine pulp segments is reduced.

For some beverage applications cutting cubes with smaller edge lengths may lead to products that are preferred from a sensoric point of view.

To allow easy cutting the pulp may be frozen before it is being cut.

The pulp may be blanched, preferable before being frozen and/or cut.

Blanching will help to sterilize the pulp. Blanching also can be used to stop unwanted enzyme activity in the pulp, to remove unwanted strong tastes and/or to soften the pulp, or to kill unwanted microorganism in the preparation to control the microbial level.

The pulp may be blanched in a sugar solution before it is frozen and/or dried. As sugar any food grade sugar can be used. An example is sucrose.

The sugar solution may contain water and sugar. Blanching is typically carried out in boiling water, although lower temperatures may be used. For example, the solution may be heated to at least about 60° C., at least about 80° C. or at least about 100° C.

The sugar solution may contain about 0.1-99 weight-% sugar, e.g. 10-30 weight-% sugar, for example about 20 weight-% sugar.

The duration of the blanching procedure will depend on the type of pulp used but will typically be between about 30 seconds and 5 minutes, for example about 1-3 minutes, such as about 2 minutes.

Such a pre-treatment of the pulp will further contribute to an excellent optical appearance of the final fruit or vegetable pulp preparation.

Further, the blanching step helps to further purify the pulp from unwanted residues of peel or other constituents which may not have been completely removed in the separation step of the pulp from the rest of the fruit or vegetable.

The process of the present invention has the advantage that the individual particles of the pulp are treated very carefully, preserving their natural character and appearance.

As a result, the fruit or vegetable pulp preparation in accordance with the present invention in a dehydrated state may have more than 50% particles of a size in the range between 0.5 mm to 30 mm.

Further ingredients, e.g., such as the density modifying ingredient, such as the at least one complex carbohydrate, maltodextrin, sucrose, trehalose, maltose, glucose, glycerine, or combinations thereof may be added to the pulp, for example after the bleaching step.

These ingredients should be added to the pulp before drying. For example, such ingredients could be added to the pulp before it is frozen.

With the addition of these ingredients, the inventors have found that the shake-down density of the final dried pulp can be varied and can for example range from 0.02 to 0.50 g/ml.

Different types of starch may be used for this purpose. For example modified starches, such as acid-treated starch, alkaline-treated starch, bleached starch, oxidized starch, enzyme-treated starches, monostarch phosphate, distarch phosphate, phosphated distarch phosphate, acetylated distarch phosphate starch acetate, acetylated distarch adipate, hydroxypropyl starch, hydroxypropyl distarch phosphate, hydroxypropyl distarch glycerol, starch sodium octenyl succinate, acetylated oxidized starch, or combinations thereof may be used.

The ideal shakedown density of the pulp particles will depend on a number of factors such as the overall average size of the pulp particle as well as the nature and density of the origin composition that was used to produce the pulp particles of the present invention.

“Shakedown density” or “tap density” of a powder is understood in the art as the ratio of its mass to the volume it occupies after it has been subjected to a fixed number of taps under specified conditions (e.g. in 30 seconds, manual jolt density meter 100 times with 8.5 height of stroke using 500 mL Stainless steel). It is conventionally expressed in grams per milliliter.

By using freeze drying technology it can be ensured that the resulting pulp maintains its floating status after reconstitution in water.

The pulp may be obtained from edible fruit or vegetables. “Edible” means a material that is approved for human or animal consumption.

For example, the pulp may be obtained from fruit of the genus citrus fruits, for example oranges, tangerines, lemons, grapefruits, pomelos; or apples; peaches; pineapples; cherries; apricots; grapes; guava; sapodillas; tomatoes; mangos; bananas; or combinations thereof.

Orange pulp is widely used and may hence be a preferred example.

Pomelos are a further preferred example, as they allow easy separation of the pulp from the whole fruit and show particular good efficiency and high yields in pulp production. Further they have a high nutritional value and are relatively inexpensive.

The composition of the present invention may be used to prepare any kind of edible composition. Edible compositions include beverages. The composition will generally be liquid prior to consumption, but this does not have to be the case.

The composition may also be to be consumed in the dry state or may be to be incorporated into other compositions, for example gel like compositions or creamy compositions such as yoghurts, ice creams or puddings. The compositions of the present invention may also be to be incorporated into dry preparations such as cakes, for example.

The composition of the present invention may also be used for cosmetic compositions and/or hygiene products such as shower gels, or face masks, for example.

In one embodiment of the present invention the composition is a powdered beverage or may be a part of a powdered beverage.

Such a powdered beverage comprises the composition of the present invention.

For example, the powdered beverage may contain at least 0.1 weight-%, at least 2 weight-% of the fruit or vegetable pulp preparation in the dry state and optionally food additives and/or food ingredients. Food additives and/or further food ingredients may be added.

The pulp preparation produced in accordance with the present invention results in a protected pulp structure and minimizes breakage during processing.

This allows that a powdered beverage composition in accordance with the present invention may have a degree of homogeneity with a coefficient of variation of at most 25%.

The present invention further extends to the use of at least one complex carbohydrate in the production of dried fruit or vegetable pulp to prevent sticking of pulp particles after drying.

The present invention also comprises the use of at least one complex carbohydrate in the production of dried fruit or vegetable pulp to adjust the density of the dried pulp.

As stated above the complex carbohydrate may preferably have a low water solubility. The complex carbohydrate may be part of a density modifying ingredient as described above.

Advantageously, using the density modifying ingredient in the preparation of a pulp preparation of the present invention will also allow coloring the pulp.

This may be achieved by adding colorants to the pulp before drying, for example together with the density modifying ingredient. Without wishing to be bound by theory the inventors believe that the complex carbohydrates allow the colour to stick better to the pulp particles so that the colour is effectively retained.

The density modifying ingredient may also be used to produce an anti-caking effect in the pulp production. This can for example be achieved if the density modifying ingredient is a starch, optionally in combination with other carbohydrates.

The density modifying ingredient may also be used to avoid breakage of dried pulp. This can for example be achieved if the density modifying ingredient is glycerol.

The density modifying ingredient, optionally in combination with sugar, may also be used to improve the flow ability of a powdered beverage preparation containing a dried pulp preparation.

Those skilled in the art will understand that they can freely combine all features of the present invention described herein, without departing from the scope of the invention as disclosed. In particular, features described for the dried fruit or vegetable pulp preparation, and/or the powdered beverage of the present invention may be applied to the uses and to the processes described in the present invention and vice versa.

Features described for the dried fruit or vegetable pulp preparation of the present invention may also apply to the powdered beverage of the present invention and vice versa.

Further advantages and features of the present invention are apparent from the following Examples and Figures.

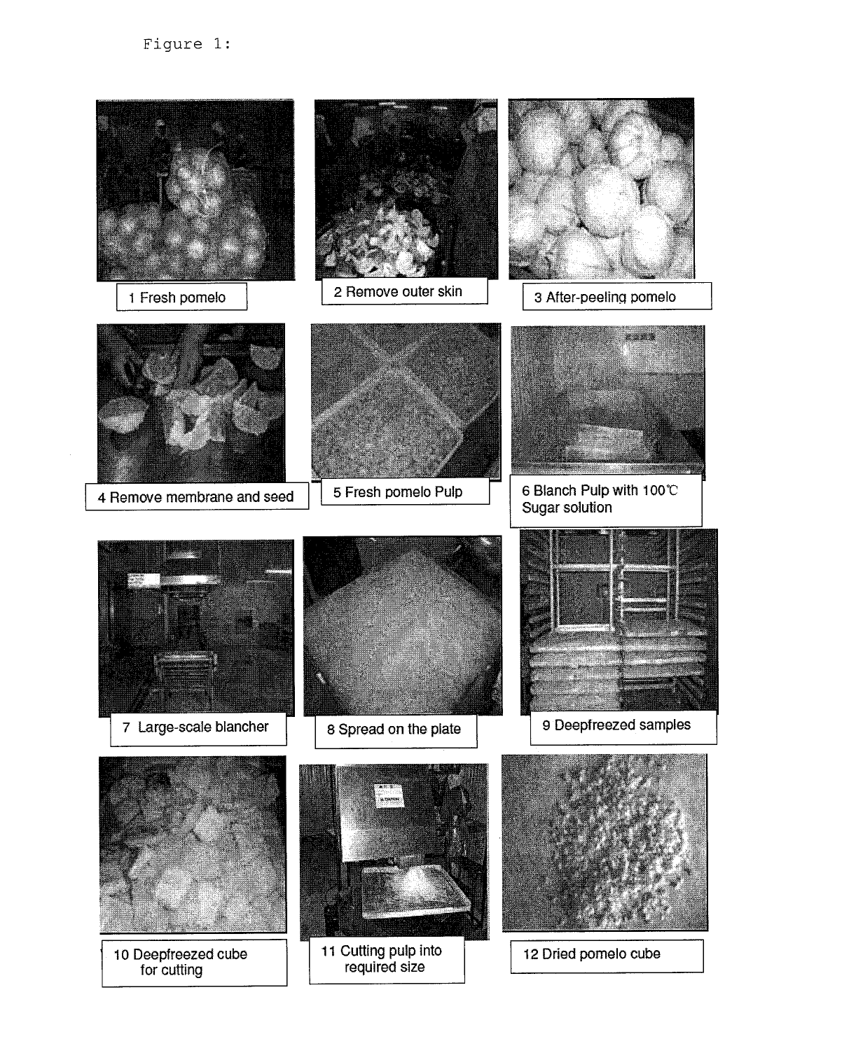

FIG. 1 shows an example of the process of the present invention.

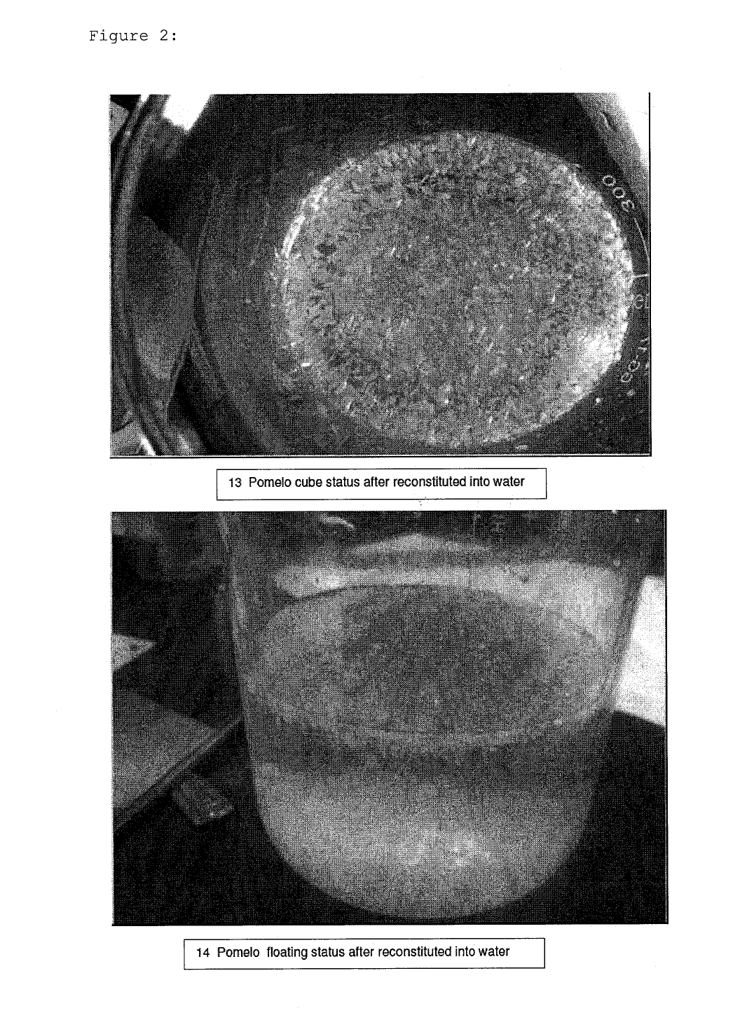

FIG. 2 shows the resulting fruit pulp obtained by the process of FIG. 1 reconstituted in water

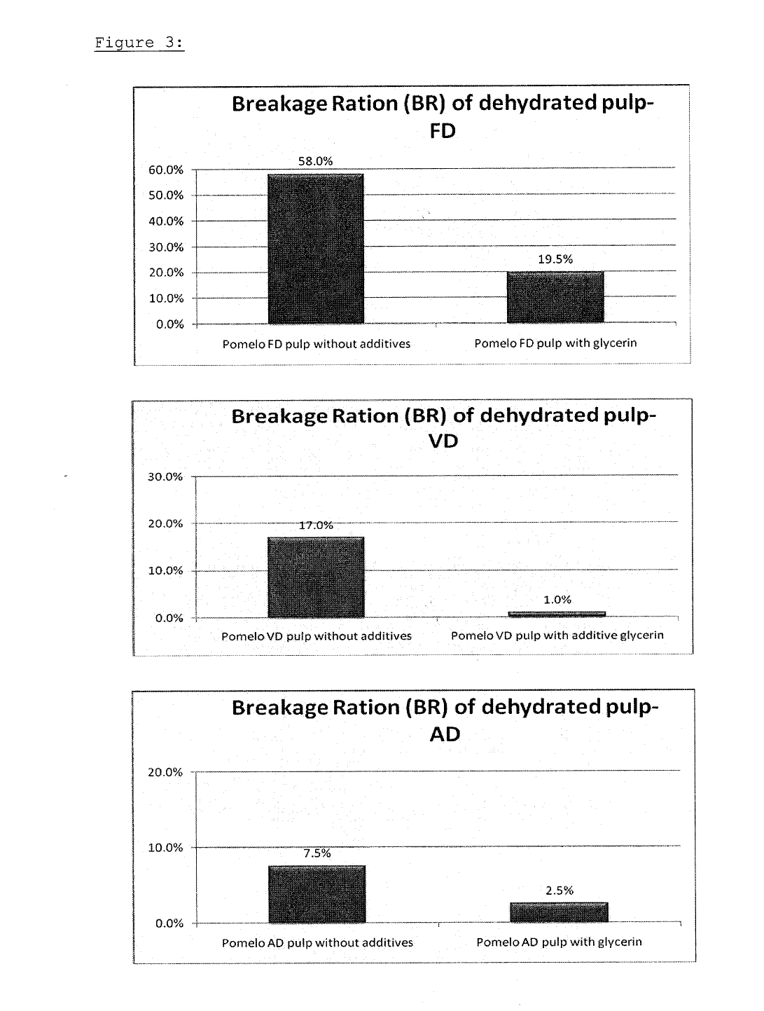

FIG. 3 shows the result of a breakage test of the dried pulp preparation of the present invention

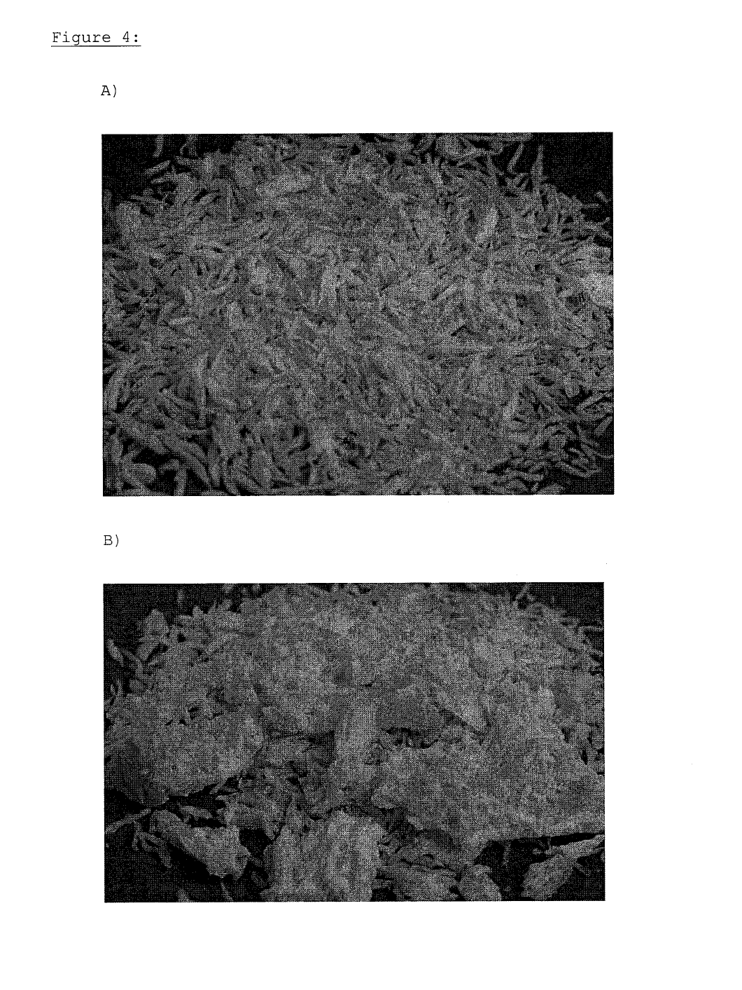

FIG. 4 shows the result of a caking test of the dried pulp preparation of the present invention; A: FD pomelo pulp with additive composition 1; B: FD pomelo pulp without additives

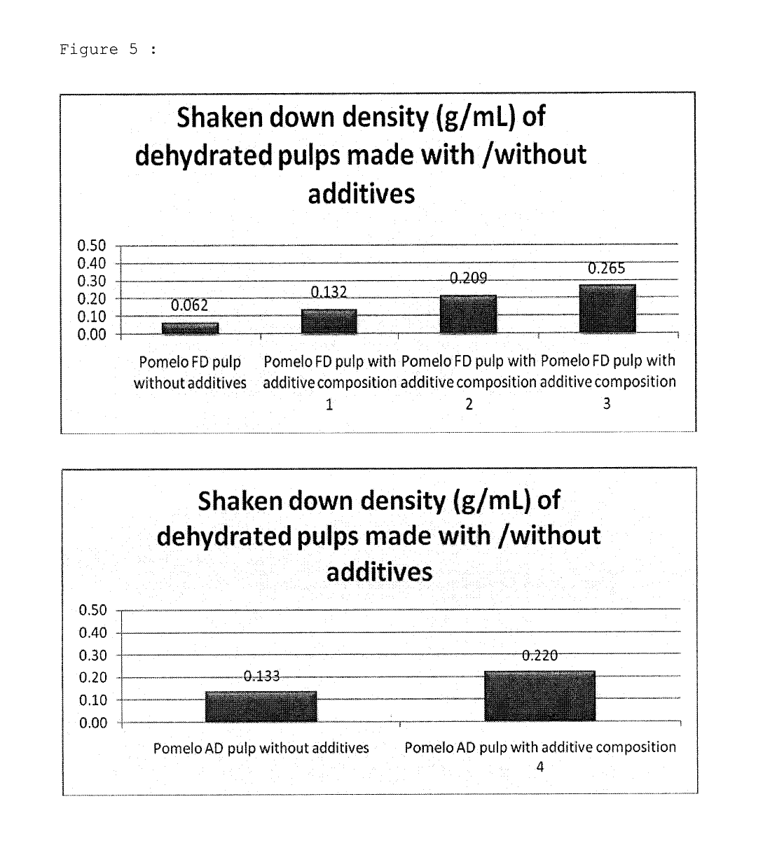

FIG. 5 shows the result of a shake down density test of the dried pulp preparation of the present invention

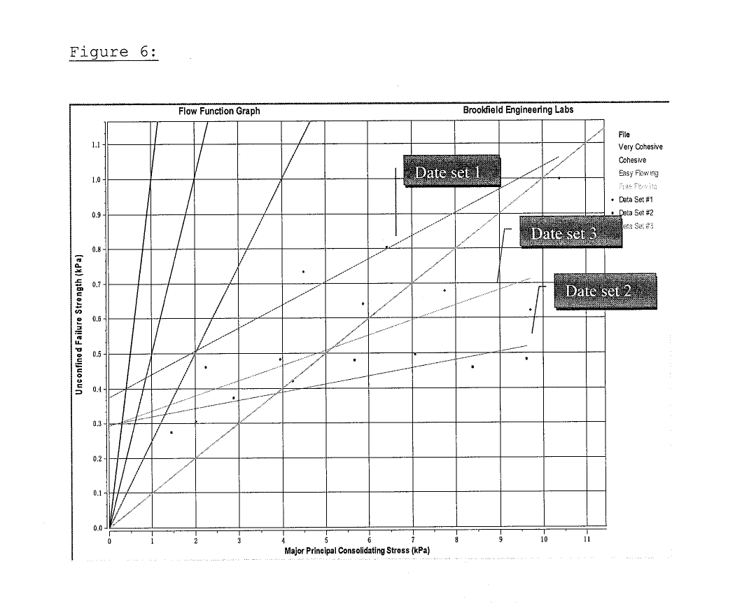

FIG. 6 shows the result of a flow ability test of the dried pulp preparation of the present invention in a final product

### EXAMPLES

Fruit pulp was separated from the whole pomelo fruit. The following table summarizes this separation procedure. The percentages are given in weight-%. About 40 weight-% of the pomelo are fruit pulp an can be used for the production of the dried fruit pulp preparation of the present invention.

| | | | | Loss | |
|---|---|---|---|---|---|
| | | | | during | Fresh |
| | Outer | Inner | Pomelo | peeling | pomelo |
| | Skin | Membrane | Nut | process | pulp |
| Guangxi | 41.8% | 14% | 5.5% | 1.8% | 36.9% |
| Pomelo | | | | | |

The inventors have prepared dried pomelo pulp in accordance with the present invention.

The process is illustrated in FIG. 1 for pomelo pulp. FIG. 2 shows the pomelo pulp floating after reconstitution in water.

The inventors have further carried out a consumer test in order to investigate whether or not dried pulp prepared from fresh unprocessed fruit or vegetables was preferred by consumers over traditionally prepared fruit pulp from the waste products of orange juice production.

The following pulps were used:

| No. | Pulp type | Description |
|---|---|---|
| 1 | 3 * 3 * 3 mm dried | Pulp is prepared from oranges |
| | orange pulp | after squeezing out juice |
| 2 | 3 * 3 * 3 mm dried | Used fresh unprocessed pomelo as |
| | pomelo pulp | starting material |
| 3 | 6 * 6 * 6 mm dried | Used fresh unprocessed pomelo as |
| | pomelo pulp | starting material |

5 g of each dried pulp preparation were mixed with 500 ml water at ambient temperature.

10 consumers were asked to evaluate the pulp samples sensorically. The results are given below:

| No. | Pulp type | Results |
|---|---|---|
| 1 | 3 * 3 * 3 mm dried | Nobody prefers sample 1 |
| | orange pulp | |
| 2 | 3 * 3 * 3 mm dried | 5 out of 10 tasters prefer sample 2 |
| | pomelo pulp | |
| 3 | 6 * 6 * 6 mm dried | 5 out of 10 tasters prefer sample 3 |
| | pomelo pulp | |

Clearly, the dried fruit or vegetable pulp preparation of the present invention is preferred by consumers. The tasters particularly noticed that sample 2 and 3 have a more chewy perception, look better and have a better mouthfeel than sample 1.

Further, the inventors have investigated the influence of sugar and other additives on the pulp yield and quality. The results are shown below.

| | | Blanching | | |
|---|---|---|---|---|
| | | of fresh | | Yield of |
| | | pulp in a | | dried |
| | | 20% sucrose | | pomelo |
| Fresh | Fresh | solution | | pulp cut into |
| unprocessed | Pomelo | for 2 min | | 3 * 3 * 3 mm |
| Pomelo | pulp | at 100° C. | Food additive | cubes |
| 32 kg | 11.7 kg | no | no | 1 kg |
| 17.8 kg | 6.6 kg | yes | 300 g starch | 1 kg |
| | | | corresponding | |
| | | | to about 5% | |
| | | | of fresh pulp | |
| | | | weight | |

The addition of sugar and/or starch allowed to further increase the pulp yield significantly. The dried pulp obtained with sucrose and starch addition contained the following:

| | Dried pomelo | | |
|---|---|---|---|
| | pulp | starch | sucrose |
| Weight-% | 57 | 33 | 10 |

The inventors further tested the effect of additives on the reduction of unwanted effects such as caking and on the overall quality of the resulting dehydrated pulp.

By means of example pulp obtained from fresh unprocessed pomelos (Guangxi) was tested.

The following table illustrates the results. The percentages are given as weight-% corresponding to the weight of the fresh pulp.

| | Cutting | |
|---|---|---|
| Added | size | |
| ingredients/additives | (mm) | Results |
| No addition | no | caking, Complete and big |
| | | pulp |
| 5% Starch | no | No caking, Complete and big |
| | | pulp |
| 2% Maltodextrin High DE | 3 * 3 * 3 | Caking after freeze drying |
| 5% Starch + 1% | 3 * 3 * 3 | Slight caking after freeze |
| Maltodextrin Low DE | | drying |
| 5% Starch | 3 * 3 * 3 | No caking and good |
| | | performing pulp |
| 5% Starch | 6 * 6 * 6 | No caking and good |
| | | performing pulp |
| 5% Starch + 0.1% Beta- | 3 * 3 * 3 | No caking and good |
| carotene | | performing |
| | | yellow pulp |
| no | 3 * 3 * 3 | caking |
| 5% Glucose | 3 * 3 * 3 | caking |
| 5% Trehalose | 3 * 3 * 3 | caking |
| 5% Starch + 0.2% Glycerol | 3 * 3 * 3 | No caking and good |
| | | performing pulp |

Consequently, the addition of complex carbohydrates, such as starch for example, allows it to improve the quality of the dehydrated pulp and to reduce caking. The addition of other low water soluble complex carbohydrates may further be used to overcome caking problems after freeze drying caused by other ingredients, such as maltodextrin. The addition of sugar can be used to adjust the density of dried pulp.

Also glycerol helps to prevent caking.

The addition of complex carbohydrates, such as starch for example, allows it further to retain coloring agents in the pulp allowing for color modifications.

The inventors have carried out further experiments to investigate the anti-breakage properties of density modifying ingredients.

Anti breakage properties are important for dehydrated pulp and its applied products under processing and transportation situations.

Further, different drying techniques were compared. In particular, pulp obtained by roller drying (RD), air drying (AD) and vacuum drying (VD) were compared to pulp obtained by freeze drying (FD).

| | |
|---|---|
| Objective | Compare anti-breakage ability of dehydrated pulps |
| | made with or without density modifying |
| | ingredients, aim to confirm the advantage of |
| | adding additives on anti-breakage ability. |
| Materials | Group 1: |
| | FD pomelo pulp without additives |
| | FD pomelo pulp with glycerin |
| | Group 2: |
| | VD pomelo pulp without additives |
| | VD pomelo pulp with glycerin |
| | Group 3: |
| | AD pomelo pulp without additives |
| | AD pomelo pulp with glycerin |
| Methodology | Sieve dehydrated pulp with 1.25 mm sieve, weigh |
| | 2.00 ± 0.01 grams oversize Pulp (>1.25 mm) into |
| | a 50 ml falcon tube, adding 15.0 ± 0.1 grams of |
| | glass beads into the tube, vortex for 1 min. |
| | Quantity of low size pulp fraction (<1.25 mm) |
| | was collected into a receiver and weighed. The |
| | Breakage Ration (BR) was calculated as: |
| | BR = W_{B}/W_{d}, |
| | where: W_{B}—weight (g) of low size fraction |
| | (<1.25 mm); |
| | W_{d}—weight of the dry sample used for |
| | test. |
| Results | Results are shown in FIG. 3. |
| Conclusion | Using pomelo pulp as starting material, results |
| | showed that using density modifying ingredients |
| | can significantly increase the anti-breakage |
| | property of dehydrated pomelo pulp, either by FD, |
| | AD or VD. |

The inventors have carried out further experiments to investigate the anti-caking properties of density modifying ingredients.

| | |
|---|---|
| Objective | Investigate if adding density modifying |
| | ingredients can produce an anti-caking effect |
| Materials | FD pomelo pulp without additives |
| | FD pomelo pulp with additive composition 1 |
| | (mixture: starch + sugar) |
| Methodology | Visual check |
| Results | Results are shown in FIG. 4. |
| Conclusion | Images clearly showed the much less caking |
| | occurred in FD pulp with density modifying |
| | ingredients. |

The inventors have carried out further experiments to investigate the shake down density of the pulp preparation of the present invention with or without density modifying ingredients.

| | |
|---|---|
| Objective | Compare shaken down density of dehydrated pulps |
| | made with or without density modifying |
| | ingredients. |
| Materials | Group 1: |
| | FD pomelo pulp without additives |
| | FD pomelo pulp with additive composition |
| | 1(mixture: starch + sugar) |
| | FD pomelo pulp with additive composition 2 |
| | (mixture: glycerin + starch) |
| | FD pomelo pulp with additive composition 3 |
| | (mixture: glycerin + starch + sucrose) |
| | Group 2: |
| | AD pomelo pulp without additives |
| | AD pomelo pulp with additive composition 4 |
| | (mixture: glycerin + sucrose) |
| Methodology | Weigh the plastic cylinder to the nearest 0.1 g |
| | (M₁), fill with pulp, place cylinder on the |
| | density meter and start the jolts according |
| | to the specified parameters (JET STAV 300, |
| | 300 jolts, stroke height at 3.0 ± 0.2 mm). |
| | Read the tapped pulp volume to the nearest 1 mL |
| | (V), Weigh the cylinder with the tapped |
| | pulp to the nearest 0.1 g (M₂). Calculate the |
| | shaken down density as: |
| | Shaken down density in g/mL = (M₂ − M₁)/V |
| | where: |
| | M₁: weight of the cylinder, in g. |
| | M₂: weight of the cylinder + tapped pulp, in |
| | g. |
| | V: volume of tapped pulp, in mL. |
| Results | Results are shown in FIG. 5. |
| Conclusion | By adding density modifying ingredients during |
| | drying processing, shaken down density of |
| | dehydrated pulp was improved, by adjusting the |
| | density modifying ingredients composition formula, |
| | pulps with different shaken down density values |
| | were obtained. |

The inventors have carried out further experiments to investigate the flow ability of the dried pulp preparation of the present invention with or without density modifying ingredients.

A key application of the dehydrated pulp preparation of the present invention is its application in powdered beverages with additional sugar content. Different dried pulp made with or without density modifying ingredients were found to change the flow behavior of finish product.

| | |
|---|---|
| Objective | Compare flow behavior of dehydrated pulp—sugar |
| | mixtures, investigate influence of density |
| | modifying ingredients on the flow behavior. |
| Materials | FD pomelo pulp without additives |
| | FD pomelo pulp with starch |
| | FD pomelo pulp with additive composition 1 |
| | (mixture: starch + sucrose) |
| Methodology | 1. Weigh 300.0 ± 0.1 grams sugar powder and |
| | dehydrated pulp (6.00 ± 0.01 grams into a sample |
| | bag, manually mix them by shaking 50 times. |
| | 2. Loading sample into the test plate according to |
| | operation manual (Brookfield Powder Flow |
| | Tester, PFT), configure parameters and test |
| | samples by PFT. |
| Results | Results are shown in FIG. 6. |
| | Data set 1: FD without additives + sugar powder |
| | Data set 2: FD with starch + sugar powder |
| | Data set 3: FD with additives composition 1 + |
| | sugar powder |
| Conclusion | Flow function test shows the curve of unconfined |
| | failure strengths versus major principle |
| | consolidating stress. The greater the flow factor |
| | values, the more free-flowing the powder. |
| | Therefore, flow function curves clearly showed |
| | that sugar mixture with FD pomelo pulp made with |
| | additive compositions has better flow ability |
| | than sugar mixture with FD pomelo pulp without |
| | density modifying ingredients. |

1. Dried fruit or vegetable pulp preparation comprising dried fruit or vegetable pulp and at least one density modifying ingredient comprising at least 0.5 weight-% compared to the dry weight of the pulp.

2. Fruit or vegetable pulp preparation in accordance with claim 1, wherein, wherein the density modifying ingredient is selected from the group consisting of complex carbohydrates and glycerol.

3. Fruit or vegetable pulp preparation in accordance with claim 2, wherein the complex carbohydrate has a low water solubility.

4. Fruit or vegetable pulp preparation in accordance with claim 1, wherein the density modifying ingredient is starch.

5. Fruit or vegetable pulp preparation in accordance with claim 1, wherein the density modifying ingredient comprises at least one sugar.

6. Fruit or vegetable pulp preparation in accordance with claim 1, wherein the pulp preparation is obtained by a process comprising the steps of separating the pulp from the fruits or vegetables, adding the density modifying ingredient to the pulp and drying the pulp.

7. Fruit or vegetable pulp preparation in accordance with claim 1, wherein the pulp is obtained from an ingredient selected from the group consisting of fresh, unprocessed fruits and vegetables.

8. Fruit or vegetable pulp preparation in accordance with claim 1, wherein the pulp is dried by a step selected from the group consisting of freeze drying, vacuum drying, air drying, roller drying, microwave drying, and combinations thereof.

9. Fruit or vegetable pulp preparation in accordance with claim 8, wherein the pulp is frozen and cut before freeze drying.

10. Fruit or vegetable pulp preparation in accordance with claim 1, wherein the pulp is blanched in a sugar solution or steam-sterilized in a solution before it is frozen and/or dried.

11. Fruit or vegetable pulp preparation in accordance with claim 1, wherein the density modifying ingredient is added to the pulp during or after the blanching step.

12. Fruit or vegetable pulp preparation in accordance with claim 1, wherein the dried fruit or vegetable pulp in a dehydrated state has more than 50% particles having a size of between 0.5 mm to 30 mm.

13. Fruit or vegetable pulp preparation in accordance with claim 1, wherein the pulp particles have a shakedown density of 0.02 g/cm³ to 0.50 g/cm³.

14. Fruit or vegetable pulp preparation in accordance with claim 1, wherein the pulp is obtained from a fruit selected from the group consisting of the genus citrus fruits, for example oranges, tangerines, lemons, grapefruits, pomelos; apples; peaches; pineapples; cherries; apricots; grapes; guava; sapodillas; tomatoes; mangos; bananas; and combinations thereof.

15. Powdered beverage comprising a fruit or vegetable pulp preparation comprising dried fruit or vegetable pulp and at least one density modifying ingredient comprising at least 0.5 weight-% compared to the dry weight of the pulp.

16. Powdered beverage in accordance with claim 15 containing at least 0.1 weight-% of the fruit or vegetable pulp preparation in the dry state.

17. A method for preventing the sticking of pulp particles after drying comprising using at least one density modifying ingredient to produce dried fruit or vegetable pulp.

18. A method for adjusting the density of the dried pulp comprising using at least one density modifying ingredient in the production of dried fruit or vegetable pulp.

19. A method for producing an anti-caking effect in the pulp production comprising using at least one density modifying ingredient in the production of dried fruit or vegetable pulp.

20. A method for avoiding breakage of dried pulp comprising using at least one density modifying ingredient in the production of dried fruit or vegetable pulp.

21. A method for improving the flow ability of a powdered beverage composition containing the dried fruit or vegetable pulp comprising using at least one density modifying ingredient in the production of dried fruit or vegetable pulp.
